(19) United States
(12) Patent Application Publication
(10) Pub. No.: US 2005/0012670 A1
(43) Pub. Date: Jan. 20, 2005

(54) Antenna arrangement, in particular for motor vehicles

(75) Inventors: Siegfried Mathiae, Munchen (DE); Peter Karl Prassmayer, Grosskarolinenfeld (DE)

Correspondence Address: NIXON & VANDERHYE, PC, 1100 N GLEBE ROAD, 8TH FLOOR, ARLINGTON, VA, 22201-4714, US

(73) Assignee: Kathrein-Werke KG, Rosenheim (DE)

(21) Appl. No.: 10/893,529

(22) Filed: Jul. 19, 2004

(30) Foreign Application Priority Data
Jul. 17, 2003 (DE) 203 11 035.8

(51) Int. Cl. H01Q 1/32

(52) U.S. Cl. 343/713; 343/700 MS

(57) ABSTRACT

An improved antenna arrangement, in particular for motor vehicles having at least two antenna devices, that is to say at least one first antenna element (3; 3′, 3″) for the mobile radio range and at least one second antenna element (13), distinguished in that the second antenna element (13) is intended for a different service than the mobile radio range, and in that the lateral distance between the at least one antenna element (3; 3′; 3″) which is provided for the first antenna arrangement (3) and the antenna element (13) for the second antenna arrangement (13) has at least sections which are <λ/8, where λ represents the wavelength of the mobile radio antenna (3).

The invention relates to an antenna arrangement, in particular for motor vehicles as claimed in the preamble of claim 1.

With regard to the large number of different mobile radio frequencies that are used, it is known for at least two-band antennas to be provided for mobile radio antennas, in particular for the motor vehicle field.

A dual-band antenna for the mobile field has been disclosed, for example, in WO 99/04452. This comprises two antenna elements which are in the form of rods, are arranged offset with respect to one another in the axial direction, and are connected to one another by means of an intermediate inductance (coil). Those ends pointing towards one another of the antenna elements which are in the form of rods, including the coil arranged between them, are fixed by means of an inductance on the one hand and by means of an externally located conductive sheath, which surrounds everything, on the other hand. This results in an LC tuned circuit between the lower and upper antenna elements. The tuned circuit can be tuned appropriately in order to ensure that, in a low frequency band, the entire antenna element device, with two antenna elements which are arranged offset with respect to one another in the axial direction, is used as an antenna while, in contrast, owing to the blocking effect of the LC tuned circuit in a higher frequency band, only the lower antenna element, with its corresponding length, acts as an antenna. Thus, reception and transmission take place only via the one antenna element that is located at the bottom in a higher frequency band range. However, the antenna nevertheless has a comparatively large physical height, for which reason it appears not to be very suitable, particularly for use as a physically short mobile radio antenna which can be fitted to the outside of motor vehicles. Furthermore, this antenna principle is restricted to a dual-band antenna and cannot be upgraded in the sense of a multiband antenna by means of which, for example, it is possible to receive three or four different band ranges. In general, it is therefore necessary to assess the bandwidth of this antenna as not being sufficient in many cases.

An antenna arrangement has also been disclosed, for example, in DE 201 11 229 U1. This prior publication describes an antenna arrangement for motor vehicles, which has a chassis above which a printed circuit board is arranged, to be precise in order to accommodate circuit components. One or more vertically projecting antenna elements, at least some of which are flat, are provided vertically with respect to the printed circuit board, which is aligned essentially horizontally, to be precise for reception of different services, or in different frequency bands for the mobile radio range.

The overall antenna arrangement is covered by a shroud, which may have a shape similar to fins. Antennas such as these are normally fitted to the motor vehicle bodywork metal sheets, for example at the junction between the motor vehicle roof and the rear windshield.

Furthermore, antenna arrangements are also known in which the printed circuit board that has been mentioned, together with the electronic circuitry components, filter circuits, etc., is first of all provided constructed on a more or less horizontal chassis, and the antenna elements are once again positioned in the vertical direction, at right angles to this. These antenna elements may, for example, comprise not only metallically conductive, self-supporting antenna element devices but, for example, may likewise once again be formed from a printed circuit board element, that is to say in general from a dielectric material, on which metallized surfaces are formed in order to create the antenna elements.

If the aim is now to receive in only one frequency band range, then one antenna element is sufficient. If the aim is to provide two or more services, or if, for example, the aim is to allow communication in different frequency bands in the mobile radio range, then, of course, two or more antenna elements, which are offset with respect to one another, or flat antenna elements are then provided.

The object of the present invention is to provide an antenna arrangement, in particular for motor vehicles, which, in addition to at least one antenna device for the mobile radio range, provides at least one antenna for further services, for example a so-called DAB antenna for reception of digital broadcast radio programs, with the antenna arrangement being intended to have good reception characteristics while occupying a small amount of space overall.

According to the invention, the object is achieved on the basis of the features specified in claim 1. Advantageous refinements of the invention are specified in the dependent claims.

The antenna arrangement according to the invention comprises, for example, an antenna with a multiband capability for the mobile radio range from 810 MHz to 960 MHz, as well as from 1710 MHz to 2170 MHz.

If a mobile radio antenna such as this were to be designed with an antenna device for reception of a further service, for example for the DAB-L band (in which case the antenna element required for this purpose would operate in a frequency range from 1452 MHz to 1467 MHz), then, in order to avoid mutual interference between the individual antenna devices for the various services and frequency ranges, attempts would be made to position these antenna devices as far away from one another as possible. This is because the mutual interference would be minimized by maximizing the horizontal distance between the antennas.

Very surprisingly, it has been found that it is possible to minimize the mutual interference between the individual antenna devices, and the lack of omni-directionality of the polar diagrams resulting from this, not only by maximizing the separation but also by ensuring that the distance between the different antenna devices which have been mentioned, that is to say the distance between at least one antenna device for the mobile radio range and a further antenna device for a further service, for example for reception in the DAB-L band, has at least sections which are less than lambda/8 (λ/8).

In one preferred embodiment, a first antenna device, which is at least provided, and a second antenna device are arranged such that both antenna devices are arranged overall at a distance of less than λ/8 apart. In this case, “λ”, when it relates to a multiband antenna for the antenna for the mobile radio range, preferably means the wavelength in the uppermost telephone frequency band.

One particularly preferred embodiment, as claimed in the dependent claim 2, provides for the antenna element terminating impedances of the mobile radio antenna and of the DAB antenna element to be optimized such that the omnidirectionality and gain of the polar diagrams, which are subject to mutual interference caused by the two antenna devices, have optimum values. This can preferably be achieved by means of a suitable filter circuit. In the case of the DAB antenna, this terminating impedance may also be formed by a selective antenna amplifier.

The invention will be explained in more detail in the following text with reference to exemplary embodiments. In this case, in detail:

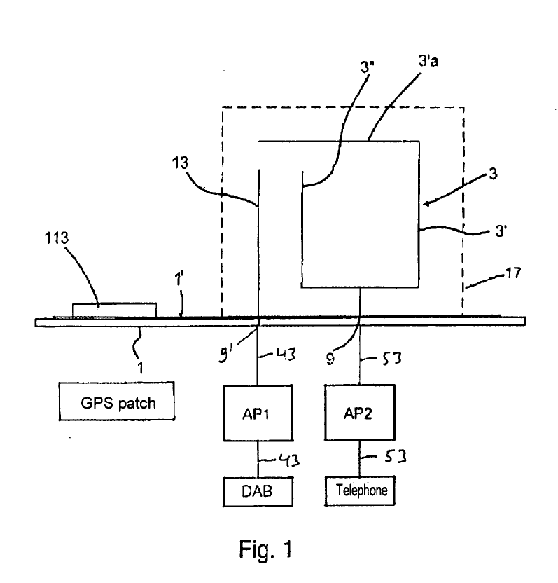

FIG. 1 shows a schematic side view of a first exemplary embodiment according to the invention;

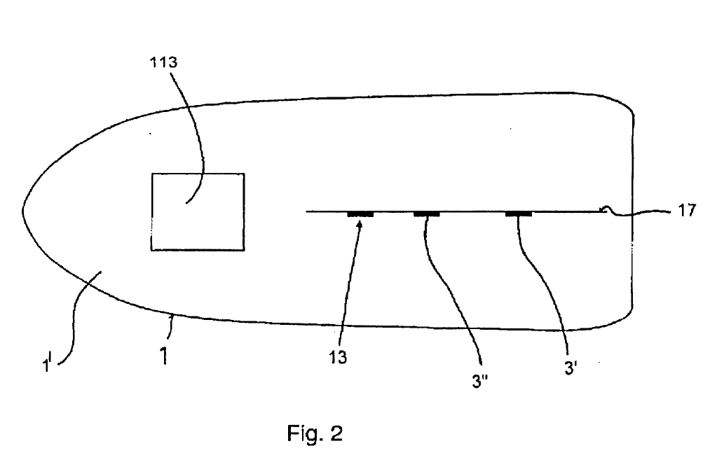

FIG. 2 shows a plan view of the exemplary embodiment shown in FIG. 1;

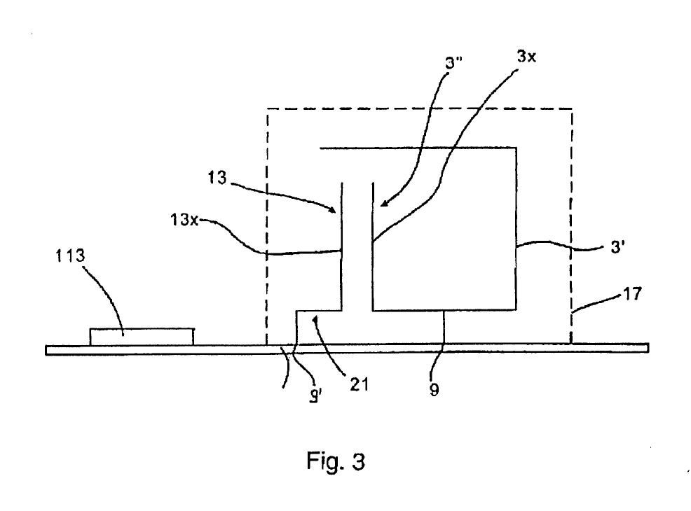

FIG. 3 shows a further exemplary embodiment, in the form of a schematic side view, similar to that shown in FIG. 1;

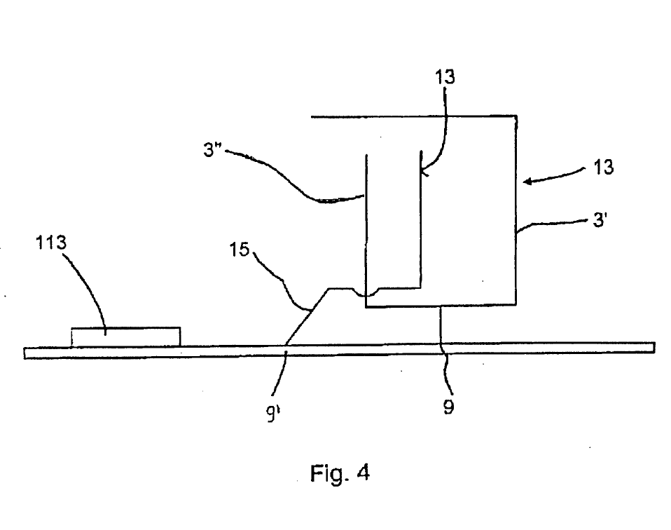

FIG. 4 shows a further modified exemplary embodiment, in the form of a schematic side view; and

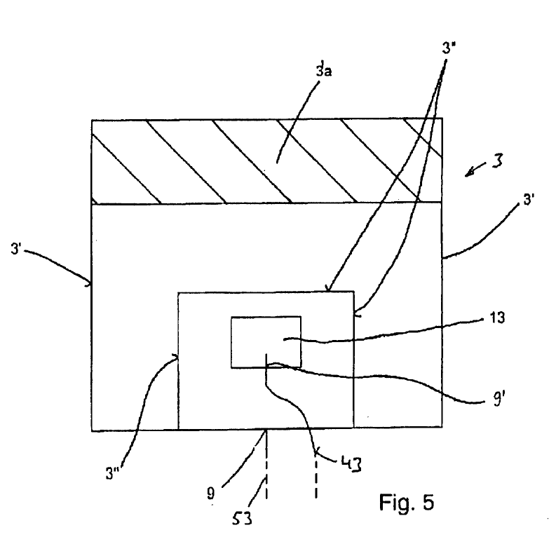

FIG. 5 shows a once again modified exemplary embodiment, in the form of a schematic side view.

FIG. 1 shows, in the form of a schematic side view, an antenna arrangement according to the invention having a chassis 1 which, for example, may be in the form of a die-casting, in particular an aluminum die-casting. As is illustrated in the schematic plan view of FIG. 2, this may have a plan view similar to a boat hull or a surfboard, that is to say running from a rather narrower or leading area to a broader, rearward area. However, this is not essential for the invention as such.

The chassis 1 is illustrated only schematically, both in FIG. 1 and in FIG. 2. It generally comprises a circular rim and a deeper area which is offset inwards from the rim, so that a printed circuit board with generally similar contours (but somewhat smaller external dimensions) can be placed or screwed on the circumferential rim of the chassis 1. The antenna elements which will be explained in the following text are then provided and mounted on the upper face of the printed circuit board. The corresponding electrical and electronic components are then provided on the lower face of the printed circuit board, being soldered on, etc., and are then located in that area in which the chassis is provided with the base that is located deeper than the surrounding rim.

In the illustrated exemplary embodiment, the antenna arrangement comprises a first antenna device 3 for the mobile radio range with an antenna element 3′ for a lower frequency band and an antenna element 3″ for the upper frequency band. The antenna element 3′ for the lower frequency range is in this case also provided with a line section 3′a which is connected, preferably approximately at right angles or horizontally, to a first or effectively vertical antenna element section 3′b, and preferably runs at least approximately parallel to the chassis 1. The two antenna elements 3′ and 3″ have a common feed 9, which is located in the center and is also referred to in some cases in the following text as a foot point 9. The antenna element 3′ for the lower frequency range is suitable, for example, for reception from 810 MHz to 960 MHz while, in contrast, the antenna element 3″ for the upper frequency band range is suitable from about 1710 MHz to 2170 MHz. Finally, the antennas that have been explained could also be provided with a roof capacitance at their free line section end.

A second antenna arrangement 13, which is suitable for reception of a different service, is now provided, with a lateral offset, in the illustrated exemplary embodiment. In the illustrated exemplary embodiment, this is provided as a DAB antenna device for reception of digital services, that is to say digital radio programs. In particular, it may also be suitable for reception of the so-called L band, that is to say for reception of only regional programs, such as those which are transmitted or are intended to be transmitted in a city area or in population centers. This further or second antenna arrangement is therefore in some cases also referred to as a DAB antenna in the following text.

Thus, in the illustrated exemplary embodiment, this DAB antenna 13 is provided on the common chassis 1 alongside the first antenna arrangement 1. The antenna is in this case in the form of a monopole antenna and may be physically/spatially in the form of a separate antenna. However, it may just as well be in the form of a conductive surface on a printed circuit board, or on some other substrate. This printed circuit board or the substrate 17 may in this case, for example, accommodate only the DAB antenna 13. A separate printed circuit board or a separate substrate 17 with corresponding conductive surfaces to form the antenna device reproduced there may likewise be provided for the first antenna arrangement. In principle, a common printed circuit board or a common substrate 17 is thus suitable, on which not only the first but also the second antenna arrangement are in the form of conductive surfaces.

The printed circuit board which has been mentioned and is illustrated in FIGS. 1 and 2 for accommodation of the antenna arrangement (or in general a substrate) is preferably mechanically anchored on the further printed circuit board 1′, which runs parallel to the chassis 1 and/or thus at right angles to or transversely with respect to the printed circuit board 17, and makes contact in an appropriate manner with the electrical and electronic components that are provided there.

Merely for the sake of completeness, it should be mentioned that a third antenna device 113 is also provided in the illustrated exemplary embodiment, which, in the illustrated exemplary embodiment, is formed from a patch antenna element 113. This patch antenna element 113 is in the form of a GPS antenna element, that is to say it is used for positioning and for finding the position of a vehicle that is equipped with the antenna according to the invention.

In the illustrated exemplary embodiment, the distance between the DAB antenna 13, that is to say between the antenna element 13 that is provided for the further service and the adjacent first antenna element 3″ in the first antenna arrangement for the higher frequency range, is <λ/8, where λ is the wavelength in the upper telephone frequency band.

Finally, as can also be seen from FIG. 1, an appropriate terminating impedance is also provided, with the aid of filter circuits, in order to improve the polar diagram, that is to say in order to achieve a more omnidirectional polar diagram and to achieve a better antenna gain. In this case, as is shown in FIG. 1, the terminating impedance for the DAB antenna element 13 may also be formed by a selective antenna amplifier.

In this case, FIG. 1 shows a connecting line 43, which leads to the DAB antenna 13. A matching circuit AP1 is provided in this connecting line 43 and leads, at its connection end opposite the antenna 13, via the line 43 to the DAB connection or to a DAB amplifier (if fitted). In contrast to the line shown in FIG. 1, the matching circuit AP1 is normally not arranged at an undefined point in the connecting line 43, but is arranged immediately adjacent to the antenna foot point 9′. To this extent, the line section 43, illustrated in FIG. 1, between the matching circuit AP1 and the antenna foot point 9′ should be regarded as being only schematic and in the form of a block diagram. This is because any lines of the antenna foot point are already used for matching transformation, and to this extent should be regarded as part of the matching circuit AP1.

A connecting line 53 in which a further matching circuit AP2 is connected likewise leads to the antenna device 3. At the connection end opposite the antenna device 3, the matching circuit AP2 is connected to a telephone or to a telephone amplifier, if fitted. The above statements also apply in this case. In contrast to the drawing, the matching circuit AP2 is also preferably arranged directly adjacent to the foot point 9 of the antenna 3, so that, in this case as well, the supposed line section 53 between the matching circuit AP2 and the foot point 9 should be regarded only as a schematic block diagram, in order to explain the functional relationship.

The matching circuits AP1 and AP2 which have been mentioned at the foot points 9′ and 9 of the two antenna devices 13 and 3 are in this case preferably provided underneath the printed circuit board arrangement 1′, so that they can be connected directly to the foot points 9′ and 9. In this case, the printed circuit boards are provided with appropriate through-plated line connections. As mentioned, the other electrical and electronic components are also preferably arranged on the lower face of the printed circuit board 1′, for which reason the shape of the chassis, which is illustrated only schematically in FIGS. 1 and 2, is in practice designed such that, in addition to a circumferential rim or flange area, a central area is provided whose base is lower than the rim or flange area, so that an accommodation area is in this case provided in the chassis 1 for the electrical and electronic components that have been mentioned, including the matching circuits AP1 and AP2. On the basis of this physical arrangement of the circuits AP1 and AP2, it is also evident that the connecting line sections 43 and 53, which are illustrated only schematically in FIG. 1, to a supposed foot point 91 and 9 thus do not exist in practice. To this extent, FIG. 1 is intended only to illustrate the ozone layout.

This matching circuit essentially carries out two functions. Firstly, the antennas are matched to 50 ohms and to the DAB input amplifier (if fitted), respectively, for their respective transmission/reception band.

Secondly, frequency ranges which are within the frequency band of the respective other antenna are transformed such that the impedance at the foot point of the antenna has an advantageous effect on the polar diagrams and on the gain of the antenna. In this case, low impedances (similar to a short circuit) up to medium impedances (for example around 50 ohms) are advantageous. High impedances (similar to an open circuit) are disadvantageous.

This means that, for example, the impedance of the connected 50 ohm cable which leads to the telephone antenna is transformed by the matching circuit AP2 in the frequency band of the telephone antenna to the complex-conjugate foot point impedance of the telephone antenna (which corresponds to power matching in the transmission band and reception band).

Secondly, the 50 ohms of the cable for the DAB reception band is transformed to a low to medium impedance.

The situation for the matching circuit AP1 is analogous to this, but the other way round. This means that, for example, the impedance of the connected 50 ohm cable which leads to the DAB antenna is transformed by the matching circuit AP1 in the frequency band of the DAB antenna to the complex-conjugate foot-point impedance of the DAB antenna (which corresponds to power matching in the reception band). Secondly, the 50 ohms of the cable for the telephone reception band is transformed to a low to medium impedance.

The exemplary embodiment illustrated in FIG. 3 shows a modified form to the extent that the DAB antenna is formed with a double angle 21 in order to produce a stepped offset. This is used to reduce the overall physical height of the DAB antenna. In this exemplary embodiment, and in contrast to FIGS. 1 and 2, the DAB antenna is not arranged such that the DAB antenna is arranged entirely within a distance of <λ/8 from the adjacent antenna element arrangement 3″ for the higher telephone frequency range. In this exemplary embodiment as shown in FIG. 3, the arrangement is chosen such that at least sections of the DAB antenna are arranged at a distance of <λ/8 from the adjacent mobile radio antenna element device 3″. This means that, in the illustrated exemplary embodiment of FIG. 3, the distance between the feed point or foot point 9 for the first antenna and antenna element arrangement 3 and the feed point or foot point 9′ of the second antenna element arrangement 13 may be >λ/8, with both antenna devices 3, 3″ and 13 having at least antenna element sections 3x and 13x whose section is <λ/8 (λ once again relates to the wavelength in the upper telephone frequency band of the antenna element arrangement 3′). Thus, in the illustrated exemplary embodiment, the outward antenna sections are arranged opposite the respective feed points and foot points 9, 21 with a separation of <λ/8.

The exemplary embodiment in FIG. 4 shows a modified form in which the DAB antenna 13 is arranged between the antenna element device 3′ for the lower frequency band and the antenna element device 3″ for the upper frequency band. In this case, the antenna element 13 or the corresponding section 13x may be arranged approximately in the center between the two antenna elements 3′, 3″ and the mobile radio antenna device 3, or else offset with respect to the center. In this case, the feed line 15 for the DAB antenna is routed in a corresponding manner and without making any contact past the feed line or the branch line of the antenna device 3 (for example on the opposite side of a printed circuit board when, for example, the first antenna arrangement 1 is formed on one face of the printed circuit board, and the second antenna arrangement 113 is formed on the opposite face of the printed circuit board).

Finally, FIG. 5 shows a further modified exemplary embodiment, in which the antenna arrangement comprises a mobile radio antenna 3 for a lower and an upper frequency band, and the antenna elements 3′ and 3″ are in this case designed to be symmetrical, that is to say symmetrical with respect to a vertical center plane. The two antenna elements 3′, 3″ are in this case formed in the manner of an inverted “U”. The DAB antenna element 13 is in this case positioned at the center, and is formed with a roof capacitance, in order to achieve a shortened form. This makes it possible to produce a particularly omnidirectional polar diagram for all the frequency ranges. As can also be seen from the illustration in FIG. 5 in this case, the antenna section 3′a is in the form of a metallized area over the whole surface. The entire antenna arrangement is therefore preferably formed or provided on a substrate, preferably in the form of a printed circuit board.

1. An antenna arrangement, for motor vehicles having at least two antenna devices, including at least one first antenna element for the mobile radio range and at least one second antenna element, wherein the second antenna element is for a different service than the mobile radio range, and wherein the lateral distance between the at least one antenna element which is provided for the first antenna arrangement and the antenna element for the second antenna arrangement has at least sections which are <λ/8, where λ represents the wavelength of the mobile radio antenna.

2. The antenna arrangement as claimed in claim 1, wherein the second antenna element is in the form of a DAB antenna element.

3. The antenna arrangement as claimed in claim 1, wherein the terminating impedance for the second antenna element comprises a filter circuit and/or an antenna amplifier, that is to say in particular a selectively operating antenna amplifier.

4. The antenna arrangement as claimed in claim 1, wherein the first antenna, which is intended for a mobile radio, has at least two antenna elements for reception in different frequency bands which are offset with respect to one another, and wherein the distance between the second antenna arrangement and the immediately adjacent antenna elements in the first antenna arrangement is <λ/8, where λ is the wavelength in the upper frequency band of the first antenna arrangement, which is provided for the mobile radio range.

5. The antenna arrangement as claimed in claim 1, wherein the first and the second antenna arrangement comprise at least antenna element sections whose separation is <λ/8.

6. The antenna arrangement as claimed in claim 1, wherein the second antenna arrangement comprises a double angle, such that the feed point or foot point of the antenna element is further away from the first antenna arrangement than an antenna section (which is offset with respect to the feed point or foot point) of the second antenna element.

7. The antenna arrangement as claimed in claim 6, wherein at least one antenna section, which is located at a distance from the respective feed point or foot point, is at a distance of <λ/8 from a corresponding antenna section of the first antenna arrangement.

8. The antenna arrangement as claimed in claim 1, wherein at least one of the antenna devices is provided with a further antenna section which runs at an angle to a first antenna section.

9. The antenna arrangement as claimed in claim 1, wherein the second antenna element for DAB reception is arranged between two antenna elements of the first antenna device for the mobile radio range.

10. The antenna arrangement as claimed in claim 1, wherein, in addition, a patch antenna, preferably in the form of a GPS antenna, is also provided, and is arranged on the chassis.

11. The antenna arrangement as claimed in claim 10, wherein the antennas on the chassis are arranged in the sequence GPS or patch antenna of the DAB antenna device and the at least one mobile radio antenna, with this arrangement relating at least to their feed points and foot points.

12. The antenna arrangement as claimed in claim 1, wherein at least one antenna element is provided with a roof capacitance.

13. The antenna arrangement as claimed in claim 1, wherein the first antenna arrangement is preceded by a matching circuit (AP2), and/or wherein the second antenna arrangement is preceded by a matching circuit (AP1).

14. The antenna arrangement as claimed in claim 13, wherein the matching circuit (AP2) is designed such that the impedance of a connected cable or of a connected line is transformed by the matching circuit (AP2) in the frequency band of the second antenna to the complex-conjugate foot-point impedance of the first antennae.

15. The antenna arrangement as claimed in claim 13, wherein the connecting cable or the connecting line for the second antenna arrangement is transformed to a low to medium impedance, preferably in a range below 80 ohms, in particular below 60 ohms, and preferably around 50 ohms or less.

16. The antenna arrangement as claimed in claim 13, wherein the matching circuit (AP1) is designed such that the impedance of a connected cable or of a connected line is transformed by the matching circuit (AP1) in the frequency band of the first antenna to the complex-conjugate foot-point impedance of the second antenna.

17. The antenna arrangement as claimed in claim 13, wherein the connecting cable or the connecting line for the first antenna is transformed to a low to medium impedance, preferably in a range below 80 ohms, in particular below 60 ohms, and preferably around 50 ohms or less.
